(19) United States
(12) Patent Application Publication
(10) Pub. No.: US 2011/0291317 A1
(43) Pub. Date: Dec. 1, 2011

(54) METHOD OF MAKING STRONG, STIFF CORE MATERIALS THAT FACILITATE THE MANUFACTURE, DISTRIBUTION AND RECYCLING OF COMPOSITE PARTS OBTAINED THEREFROM

(76) Inventor: Robert Guzauskas, West Palm Beach, FL (US)

(21) Appl. No.: 13/036,912

(22) Filed: Feb. 28, 2011

Related U.S. Application Data
(60) Provisional application No. 61/309,629, filed on Mar. 2, 2010.

(51) Int. Cl. B29C 41/20; C08K 13/04; C08L 89/00; C08L 5/00; C08K 7/22; C08L 35/02

(52) U.S. Cl. 264/129; 523/218; 524/853; 524/704; 524/732

(57) ABSTRACT

Moldable, curable, reinforcing particle-filled compositions and methods for making the compositions are provided. The moldable compositions are characterized by high loadings of reinforcing filler particles in a thermosetting matrix and, as such, can be strong, yet lightweight. The moldable compositions can be formed into shaped cores and cured to provide a variety of articles. Optionally, a layer of reinforcing material can be applied over the shaped cores to finish and strengthen the final article.

### CROSS-REFERENCE TO RELATED APPLICATIONS

This application claims priority from U.S. provisional patent application Ser. No. 61/309,629, filed on Mar. 2, 2010, the entire disclosure of which is incorporated herein by reference.

### BACKGROUND

Thermosetting moldable compositions are used in many industrial applications, including model making, boat building, and the production of utensils, automotive parts and bathroom fixtures. It is desirable to reinforce such compositions with filler materials. However, it is difficult to do so at high loadings without sacrificing characteristics such as processability and strength.

### SUMMARY

One aspect of the invention provides a method for making moldable, curable, particle-filled reinforcing compositions. The method comprises mixing a dry powder comprising thickener particles with reinforcing filler particles; adding a curable liquid resin to the mixture; and (c) aging the mixture comprising the thickener, the reinforcing filler particles and the curable liquid resin, whereby the liquid composition is at least partially absorbed by the thickener particles to form an uncured moldable composition. The present methods are capable of providing compositions having high loadings of reinforcing filler particles. For example, the compositions can comprise at least 50 percent by volume of the reinforcing filler particles.

In some embodiments, the thickener particles comprise a linear thermoplastic polymer, such as an acrylic resin. In some embodiments, the reinforcing filler particles are hollow particles and/or fibers.

The high loadings of the reinforcing filler particles are facilitated by using thickener particles having small particle sizes. Thus, in some embodiments, the thickener particles have an average particle size of no greater than about 1000 μm. This includes embodiments in which the thickener particles have an average particle size of no greater than about 1 μm. Relative to the thickener particles, the reinforcing filler particles case be quite large. For example, in some embodiments, the reinforcing filler particles have an average size of at least 0.5 mm.

The present methods can further include the steps of molding the uncured moldable composite material into a shaped article core and applying a reinforcing material over the shaped article core and curing the curable resin.

### DETAILED DESCRIPTION

Methods for making moldable, curable, particle-filled reinforcing compositions are provided. The moldable compositions are characterized by high loadings of reinforcing filler particles in a thermosetting paste and, as such, can be strong, yet lightweight. The moldable compositions can be formed into shaped cores and cured to provide a variety of articles. The uncured compositions can have a greatly extended shelf life to facilitate transport of these compositions. The compositions can be used as core materials under fiber reinforced, composite laminates (skins). As such, the compositions can replace foams and balsa wood cores with reinforcing filler particles that are stronger and stiffer and more resistant to stress and strain that causes part failure. Typically layers of fibrous reinforcing material are applied over the shaped cores to finish and strengthen the part.

One method of producing the moldable, curable, particle-filled compositions is to mix particulate reinforcing fillers with particulate thickeners into a curable liquid resin solution. It is desirable that the thickener particles be partially soluble or absorbent of the liquid resin solution. It is also desirable to maximize the loading of reinforcing filler particles while at the same time controlling the viscosity and tack of the mix to facilitate molding and distribution of the uncured mixture. This is accomplished by mixing the reinforcing filler particles with a dry powder comprising thickener particles, wherein the soluble or absorbent thickener particles and the reinforcing filler particles are sized such that the smallest thickener particles can form a thin coating on the surfaces of the reinforcing filler particles, and/or the largest thickener particles may lie alone in the interstices between reinforcing filler particles. This makes it possible to introduce a sufficient quantity of thickener particles to the mixture, while still allowing the reinforcing filler particles in the mixture to pack closely. After the reinforcing filler particles have been interspersed with thickener powder, a liquid composition comprising a solution of curable thermosetting monomers, oligomers, polymers or a combination thereof is added. This liquid contains a solvent capable of dissolving both the curable resin(s) and the thickener particles. The viscosity of the liquid composition is desirably sufficiently low such that it forms a moldable paste with the reinforcing filler particles and the dissolving or absorbent thickener particles, wherein the moldable paste has a high loading of closely packed reinforcing filler particles. A variation of this method would omit the liquid resin solution. Low fusing thickener particles on reinforcing filler particles melt when heated. Cooling produces a solid core.

A second method of producing the moldable, curable, particle-filled compositions is to mix particulate reinforcing fillers with water soluble or water absorbent particulate thickeners into water (water extended plastic), or a plasticizer (plastisol) or a plasticizer and solvent (organisol). Water will activate polyelectrolytes and hydrophilic groups of the thickener particles. Examples of suitable thickener particles for this embodiment include polyelectrolytes, gypsum, ionomer powders, gelatins, starches or flours of animal or plant products, and water extended plastics (e.g., polyesters). A water extended plastic is a plastic which, when incorporated into an aqueous emulsion, becomes the continuous phase while the water acts as a filler or extender. Water soluble plastics used in the coatings industry can also serve as binders for the reinforcing filler particles. In some embodiments, the water based compositions will be biodegradable, nonflammable and less toxic than similar hydrocarbon mixtures. Plastisols and organisols can be easily poured or injected and are amendable to forming hollow cores which combined with hollow fillers help reduce the weight of the structure.

These thermosetting moldable compositions can be dispensed as pastes to be poured or injected or extruded into a mold. Alternately, the mixture can be aged (matured) and dispensed as a premixed dough and then molded using techniques and conditions of temperature and pressure to form a wide range of articles. These compositions can be used between skins of reinforcing fibers in industrial applications such as model making, boat building, and the production of utensils, automotive parts, bathroom fixtures and wherever a core, a spacer or a filler is desired to enhance physical properties, reduce weight or reduce cost combined with ease of processing. The core material separates and supports the fibrous skins. The stiffness of the composite part increases as the cube of the distance between the fiber filled skins.

### Thickener Particles:

In the present methods, the thickener particles dissolve or absorb the liquid to form a binder or matrix or network polymer(s). The thickener particles can be composed of any material that initially takes up (e.g., absorbs or adsorbs) the liquid component to form a moldable, curable composition. The dissolution of the thickener particles in the liquid composition or the absorption of the liquid composition by thickener particles may delay the viscosity build up. This maturation process allows the thickener particles time to convert the slurry of reinforcing filler particles and the liquid composition into a paste, a moldable dough or a gelatin. The paste, moldable dough, or gelatin is desirably suitable for dispensing, distribution and placement to molders and (composite) parts manufacture.

The maturation process (i.e., the time period in which the thickener particles slowly take up the liquid, swell and begin to dissolve) can typically take from a few minutes to a few days. The end of the maturation process is signaled by a plateau in the viscosity of the paste or dough. The resulting paste or dough can remain moldable at a low pressure for many months and as long as, for example, two years when totally devoid of unstable initiators of polymerization and the liquid protected from evaporation. When the thickener particles are devoid of active initiators, more stable initiators can be incorporated into the molding compositions to avoid premature gelation of the dough. This facilitates a long shelf life and can greatly extend market distribution channels.

Particles of linear thermoplastic resins are particularly well-suited for use as thickener particles. Linear thermoplastic polymer particles absorb liquid and dissolve slowly in the liquid composition or in a common solvent therein. As the dry polymer blooms it binds the liquid solvent often reducing volatile organic emissions (VOCs). Example of linear thermoplastic polymers include acrylics, polyesters, polystyrenes, polyvinyl esters, polyvinyl acetate (PVA), polyvinyl chloride (PVC) and polyvinyl alcohol (PVOH), polyols (urethanes), maleic acid polymers, polysaccharides, proteins, polyamides, polyamino acids, fatty acids and soaps of fatty acids, ionomers and the like. Other suitable thickener particles include fumed silica and nano particles with very high surface area per gram. These miniscule particles also adsorb liquids and serve as reinforcing particles.

Examples of acrylic resin thickeners are provided in U.S. Pat. No. 7,183,334 and U.S. Patent Publication No. 2007/0249774, the entire disclosures of which are incorporated herein by reference. The term “acrylic resins” as used herein is intended to include acrylic monomers of the structure:

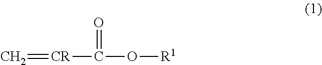

wherein R═H or a hydrocarbon based radical, and R¹=a hydrocarbon based radical; and oligomers, polymers and copolymers thereof. Included within the acrylic polymers are linear, branched and cross-linked homopolymers. Included within the acrylic copolymers are graft copolymers, random copolymers, block copolymers and cross-linked copolymers with two or more acrylate monomers of formula 1 or different monomers such as styrene and acrylonitrile (ASA resins) and acrylamide and methacrylamide. The preferred acrylic resins are the monomers, polymers and copolymers, both linear and cross-linked, of methyl methacrylate, ethyl methacrylate and butyl methacrylate.

The hydrocarbon based radicals of R and R¹ include methyl, ethyl, propyl, isopropyl, and n-butyl, sec-butyl, isobutyl, tert-butyl, hexyl, heptyl, 2-heptyl, 2-ethylhexyl, 2-ethylbutyl, dodecyl, hexadecyl, 2-ethoxyethyl isobornyl and cyclohexyl. Preferred acrylates have R and R¹ selected from the C₁-C₄ series.

The term “acrylic resins” as used herein is also intended to include vinyl ester resins such as those derived from Bis-GMA. Bis-GMA is essentially an oligomer of the formula

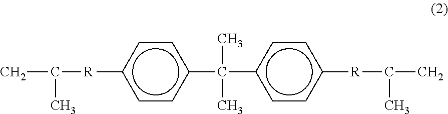

wherein R is

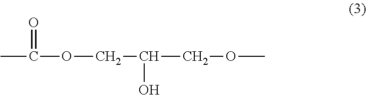

which can be obtained by reaction of one molecule of bisphenol-A and 2 molecules of glycidylmethacrylate or by reaction of diglycidylether of bisphenol-A with methacrylic acid. Similar vinyl esters can be prepared using other polyepoxides and unsaturated monocarboxylic acids. These resins are cured at ambient or elevated temperatures by free-radical polymerization in a manner analogous to the acrylic resins containing monomers of formula 1 above.

The term “solid acrylic resin” as used herein is intended to include single beads of linear polymer and aggregates of many small beads into one particle.

### Reinforcing Filler Particles:

The preferred reinforcing, filler particle is hollow. The reinforcing filler particles are included in the present compositions to provide lightweight articles with high strength, stiffness and toughness. As such, the reinforcing filler particles can be made from a wide range of materials, provided those materials are insoluble in the liquid component. Moreover, the reinforcing filler particles can comprise a combination of different types and sizes of particles or aggregates. Any particles that serve to reinforce articles made from the cured compositions and that are sized such that they can be coated with a thin layer of the matrix binder can be considered reinforcing filler particles. Though the preferred reinforcing filler particles are hollow, solid particles, porous particles, or a combination thereof can also be used to facilitate close packing, increase density and core strength and stiffness. Examples of close packing can be found in diagrams of crystals. In some embodiments, the surfaces of the reinforcing filler particles can be functionalized such that they form bonds (e.g., covalent or non-covalent bonds) with the thermosetting matrix in cured articles made from the moldable compositions. The reinforcing filler particles can have a wide variety of shapes, including but not limited to, spherical or substantially spherical, elongated, symmetrical or asymmetrical. Examples of suitable reinforcing filler particles include the solid and/or hollow polygonal shaped closed cells described in U.S. Patent Publication 2009/0092820, the entire disclosure of which is incorporated herein by reference.

Examples of suitable materials from which the reinforcing filler particles can be made include both inorganic and organic materials. Examples of reinforcing filler particles include phenolic balloons and silanated glass ballotini. In some embodiments, the reinforcing filler particles may be plant or animal materials: Examples include buckwheat, kernels of corn, diatomaceous earth or shells of mollusks.

### Additional Filler Particles:

Provided that the compositions include at least one set of reinforcing filler particles sized such that the smallest thickener particle can form a coating thereon, and/or such that the largest thickener particles can lie in the interstices between close-packed reinforcing filler particles, optionally additional filler particles can also be included. In such embodiments, the previously described reinforcing filler particles are referred to as “primary reinforcing filler particles” and the other filler particles are referred to as “additional filler particles.” These additional filler particles may also play a role in reinforcing cured articles made from the present compositions. These additional filler particles are smaller than the primary reinforcing filler particles and can be used to fill the interstices between the primary reinforcing filler particles. These additional filler particles reduce resin demand in the mixtures, increase the viscosity of the mixtures, prevent separation by settling in the uncured mixture and stiffen and strengthen the finished core. The additional filler particles may be composed of the same or different materials as the primary reinforcing filler particles.

### Particle Sizing:

The size of the thickener particles is governed by the solubility of the thickener particles in the liquid solvent(s) and the method and speed of manufacturing the core paste. Generally larger particles will dissolve and thicken slower than fine particles. The so called, Core Shell, (agglomerates of very fine particles) tend to dissolve very rapidly producing an abrupt rise in paste viscosity. Core shell particle size can exceed 500 microns in diameter depending on the polymer composition. Whereas a similar, single bead polymer produced from a simple emulsion might have a diameter of only 20 microns to produce equivalent viscosity in the same time. Thickener particles should be small and numerous enough relative to the reinforcing filler particles to allow the thickener solution to form a thin, slightly tacky coating of the thickener matrix on the surface of the reinforcing filler particles. The viscous thickener matrix serves to bind the mixture. In addition, the amount of thickener particles included in the mixture of thickener particles and reinforcing filler particles should be sufficiently low, 1) to allow for relatively close packing of the reinforcing filler particles in the mixture and, therefore, a high loading of the reinforcing filler particles in the curable, moldable compositions and cured articles made there from; 2) for the dispensing of the raw paste mixture. The amount of thickener particles in the mixture is easily determined as a weight percent (wt. %) of the total mixture or as parts per hundred (pph) of the curable liquid component of the mixture.

The actual sizes of the reinforcing filler particles can vary over a wide range, depending upon the desired strength, stiffness, weight and economics desired. By way of illustration only, in some embodiments, the reinforcing filler particles will have an average size of at least about 0.5 mm. This includes embodiments wherein the average size of the reinforcing filler particles is at least about 1 mm and further includes embodiments wherein the average size of the filler particles is at least about 1 cm. However, other embodiments can include reinforcing filler particles having sizes outside of these ranges. For the purposes of this invention, the average size of the particles in a collection of particles having non-symmetric geometry refers to the smallest dimension of the particles. For example, the average size for a collection of cylindrically-shaped particles will be determined by the width, rather than the length, of the particles.

The optimal size and quantity of the thickener particles will depend 1) on the required mixing and dispensing time; 2) on the surface area of the reinforcing filler particles included in the composition; and 3) on the size of the reinforcing filler particles. Thus, the size and quantity of the thickener particles can also vary over a wide range. The preferred embodiment is an aggregate of size and shape. By way of illustration only, in some embodiments the thickener particles will have an average size (i.e., average diameter) of no greater than 500 μm. In other mixtures, the thickener particles have an average size no greater than 1 micron. This includes embodiments in which the thickener particles are nano sized particles (e.g., having diameters diameters of 100 nm or less).

Because the thickener particles dissolve in the liquid to form a thin coating on the reinforcing filler particles in the mixture, the loading of the reinforcing filler particles in the mixtures can be high. For example, in some embodiments of the present compositions, the volume percent of filler particles is at least 50 percent. This includes embodiments in which the volume percent of filler particles is at least 55 percent, at least 60 percent, at least 65 percent, and at least 70 percent.

For example only, in terms of relative weight percentage in the present compositions, in some embodiments, the compositions include a content of at least about 60 percent by weight (wt. %) thickener particles and no greater than about 40 percent by weight (wt. %) liquid, based only on the total weight of the thickener particles and the liquid. This includes embodiments in which the compositions have a content of at least about 65 percent by weight (wt. %) thickener particles and no greater than about 35 percent by weight (wt. %) liquid, based only on the total weight of the thickener particles and the liquid. It should be noted that the reinforcing filler particles and thickener particles compete for the liquid component of the mixture. Thus, reinforcing filler particles added to the mix can consume liquid needed for thickener particle solvation. Therefore, one may find it advantageous to add more liquid to wet the surface of the aggregates. The final viscosity of the paste can be titrated and then scaled up to industrial quantity by one skilled in the art.

### The Liquid Composition:

The liquid used to produce the curable, moldable compositions includes thermosetting monomers, oligomers, polymers, or a combination thereof which form a thermoset matrix or binder for the reinforcing filler particles when the moldable compositions are cured. The liquid component may also include common solvents able to dissolve both the curable resins and thickener particles. Examples include methylene chloride, acetone and butyl acetate. The monomers, oligomers and/or polymers have vinyl unsaturation which cures to a thermoset polymer in the presence of a polymerization initiator. The liquid, aqueous or curable, solution must be able to solubilize the thickener particles so that the liquid solution will be taken up by the thickener particles in a process sometimes called, scavenging. Suitable monomers, oligomers and polymers include the liquid acrylic monomers and liquid oligomers (diacrylates and dimethacrylates) and polymers obtained therefrom. Suitable liquid oligomers and polymers also include liquid glycidyl methacrylate (GMA), bis-GMA oligomers and polymers and further include liquid polyester resins and liquid styrene monomers and oligomers. Examples of dimethacrylates include ethylene glycol dimethacrylate (EGDMA), triethylene glycol dimethacrylate (TEGDMA) and urethane dimethacrylate (UEDMA). The liquid can also be water when the thickeners are water soluble, water absorbent or water absorbent.

The liquid composition is desirably present in an amount sufficient to at least wet all of the dry surface area of all of the dry ingredients of an embodiment and provide a binding polymer matrix upon cure. However, beyond this, the liquid composition content is desirably minimized such that it allows for close packing and high loading of the reinforcing filler particles and minimizes the tackiness of the finished paste or dough.

The liquid composition desirably has a sufficiently low viscosity so that it facilitates close packing of the reinforcing filler particles in the uncured, moldable composition. Thus, in at least some embodiments, the liquid composition has a viscosity no greater than that of the solvent or the thickener particles.

### Polymerization Initiators:

The moldable compositions can include an polymerization initiator. The initiator preferably has an activity which can be restrained (inhibited/retarded), desirably at ambient conditions and elevated temperatures. Free-radical initiators which initiate polymerization by exposure to either elevated temperatures above ambient temperature and/or exposure to visible light or ionizing radiation are well suited for providing moldable compositions with good shelf stability

The uncured, moldable compositions can contain conventional additives where desired to obtain a particular additive effect either in processing or in the finished product. These include processing aids, surface property modifiers, physical property modifiers, and electrical property modifiers. Specific additives include anti-blocking agents, anti-caking agents, anti-foaming agents, antioxidants, anti-slip agents, anti-static agents, blowing agent, coupling agents, compatibilizers, dispersing aids, flatting agents, inhibitors, catalysts, accelerators/promoters, heat stabilizers, light stabilizers, wetting agents, plasticizers, extenders, thixotropics, flame, fire and smoke retarders, internal mold releases, lubricants, impact modifiers, tougheners, coloring/dyes/pigments, odorants and deodorants, low profile or low shrink additives, low pressure additives, clarifying agents, opacifiers, thickeners, viscosity control agents, permeability modifiers, biodegrading agents, foaming agents, solvents and waxes. Conventional colorants can be used, such as dyes or pigments when necessary. In dental appliances, titanium dioxide and cadmium (peach colored) pigments are often used. Other suitable additives are dispersing agents. An example of suitable dispersing agent is fumed silica sold under the trade name Cab-O—Sil®. Another is Castor Oil. Other additives include surfactants and mold release agents.

### Exemplary Embodiment:

By way of illustration only, one exemplary embodiment of the present compositions includes thickener particles comprising an acrylic resin and reinforcing filler particles comprising hollow polymeric cells. One variation of this embodiment further includes fumed silica as a dispersing agent.

### Reinforcing Material:

The curable, moldable compositions can be formed into a variety of shaped cores and said cores may optionally be further reinforced by applying a layer (skin) of a reinforcing material over the shaped core to provide a finished article. This reinforcing material may itself include reinforcing matter, such as particles or fibers, and may be applied to at least a portion of the surface of a shaped core prior to cure or post-cure. Reinforcing layers in the form of ‘face sheets’ are described in U.S. Patent Publication No. 2009/0092820. In one exemplary embodiment, the reinforcing layer is a fiber-filled composite skin.

### Methods of Making Moldable Compositions and Cured Articles:

The moldable compositions can be prepared using conventional mixing equipment such as a high shear blender and low shear mixer. The components of the moldable composition are first combined into two separate portions, a liquid mixture portion and solid mixture portion. The liquid mixture includes the thermosetting monomers, oligomers and/or polymers and, optionally, liquid additives, including surfactants and/or catalyst. Water may be the liquid. The dry ingredients can be mixed thoroughly in a low shear mixer like a tumbler and typically include the thickener particles, reinforcing filler particles, additional fillers, colorants, and dispersing agents. Following preparation of the solid and liquid mixture portions, the two portions can be combined in a low shear mixer. The resulting uncured composition can be dispensed by, for example, injection, pultrusion, pouring, vacuum forming or compression methods for later curing. Or the mixture can stand (mature) for a period of time, desirably with occasional stirring or inversion. With the appropriate curing initiator blended therein, the uncured, moldable compositions can be hardened by the application of heat, exposure to UV or visible light, ionizing radiation or chemical reaction to form a suitable core for the contemplated composite part.

As used herein, and unless otherwise specified, “a” or “an” means “one or more.” All patents, applications, references, and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like includes the number recited and refers to ranges which can be subsequently broken down into subranges as discussed above. Finally, as will be understood by one skilled in the art, a range includes each individual member.

It is specifically intended that the present methods of this invention not be limited to the embodiments and illustrations contained herein, but include modified forms of those embodiments including portions of the embodiments and combinations of elements of different embodiments as come within the scope of the following claims.

What is claimed is:

1. A method for making moldable, curable, particle-filled reinforcing compositions, the method comprising:
(a) mixing a dry powder comprising thickener particles with reinforcing filler particles;
(b) adding a curable liquid resin to the mixture; and
(c) aging the mixture comprising the thickener, the reinforcing filler particles and the curable liquid resin, whereby the liquid composition is at least partially absorbed by the thickener particles to form an uncured moldable composition comprising at least 50 percent by volume of the reinforcing filler particles.

2. The method of claim 1, wherein the thickener particles comprise a linear thermoplastic polymer.

3. The method of claim 2, wherein the linear thermoplastic polymer comprises an acrylic resin.

4. The method of claim 1, wherein the reinforcing filler particles are hollow particles.

5. The method of claim 1, wherein the thickener particles have an average particle size of no greater than about 1000 μm.

6. The method of claim 1, wherein the thickener particles have an average particle size of no greater than about 1 μm.

7. The method of claim 6, wherein the reinforcing filler particles have an average size of at least 0.5 mm.

8. The method of claim 1, further comprising molding the uncured moldable composite material into a shaped article core.

9. The method of claim 8, further comprising applying a reinforcing material over the shaped article core and curing the curable resin.

10. The method of claim 8, wherein the reinforcing material comprises reinforcing fibers.

11. The method of claim 1, wherein the thickener particles make up at least about 1.0 percent by weight (wt. %) of the total weight of the thickener particles and liquid resin in the mixture.

12. The method of claim 1, wherein the thickener particles comprise a carbohydrate homopolysaccharide or heteropolysaccharide or sugar alcohol or polyelectrolyte polymer.

13. The method of claim 1, wherein the thickener particles comprise hydrophilic polyester particles.

14. The method of claim 2, wherein the thickener particles comprise polyelectrolytes or polar and hydrophilic groups.

15. The method of claim 1, wherein the uncured moldable composition comprising at least 60 percent by volume of the reinforcing filler particles.

16. The method of claim 1, wherein the uncured moldable composition comprises at least 70 percent by volume of the reinforcing filler particles.

17. The method of claim 1, wherein the weight percent of thickener particles is at least about 60 weight percent and the weight percent of curable liquid resin is no greater than 40 weight percent, based on the total weight of the thickener particles and liquid resin in the mixture.

18. The method of claim 1, wherein the weight percent of thickener particles is at least about 65 weight percent and the weight percent of curable liquid resin is no greater than 35 weight percent, based on the total weight of the thickener particles and liquid resin in the mixture.
